(19) United States
(12) Patent Application Publication
(10) Pub. No.: US 2025/0374906 A1
(43) Pub. Date: Dec. 11, 2025

(54) AUTOMATED INSECT DETECTION AND RESPONSE PRESCRIPTION

(71) Applicant: The Curators of the University of Missouri, Columbia, MO (US)

(72) Inventors: Amit Nath Jha, Rolla, MO (US); Vishesh Kumar Tanwar, Rolla, MO (US); Ashish Gupta, Rolla, MO (US); Sajal K. Das, Rolla, MO (US)

(73) Assignee: The Curators of the University of Missouri, Columbia, MO (US)

(21) Appl. No.: 19/230,874

(22) Filed: Jun. 6, 2025

Related U.S. Application Data
(60) Provisional application No. 63/656,859, filed on Jun. 6, 2024.

(51) Int. Cl. A01M 1/02; A01M 1/14; G06T 7/00

(52) U.S. Cl. CPC A01M 1/026; A01M 1/14; G06T 7/0002

(57) ABSTRACT

A field analysis system includes a plurality of sensor stations, a field data processor, a gateway server, and an access device. Each sensor station includes an imaging device, at least one agricultural sensor, and a sticky trap. The field data processor includes a field data processor configured to receive data collected by the plurality of sensor stations. Each of the sensor stations intermittently collects data in the form of image data comprising images taken of the sticky trap using the imaging device, and sensor data taken from the at least one agricultural sensor. A sensor station processor is configured to extract insect population data from the image data. The insect population data and sensor data are transmitted to the field data processor where it is processed to generate a prescribed field action. This is transmitted to a cloud server via the gateway server. The cloud server is accessible by the access device.

### CROSS-REFERENCE TO RELATED APPLICATION

This application claims priority to U.S. Provisional Patent Application No. 63/656,859, filed Jun. 6, 2024, the entire disclosure of which is incorporated herein by reference.

### STATEMENT OF GOVERNMENT SUPPORT

This invention was made with government support under Grant No. 1952045, awarded by the National Science Foundation. The government has certain rights in the invention.

### FIELD

The present disclosure pertains to insect identification and control on farmlands, and more particularly to the use of computer technology for autonomously analyzing insect populations and prescribing a field action in response.

### BACKGROUND

Insect populations are of significant concern to farmers. In the United States, major crops like corn and soybean are heavily impacted by insects such as corn rootworm beetles (CRWB), and aphids. Insect damage (e.g., crop consumption) can spread from a few square meters to the crop in its entirety if insecticides are not applied properly (e.g., in sufficient quantity and in a timely manner). Many of the insects which are detrimental to crop health are small, visually similar (e.g., difficult to distinguish from one another without close inspection), and hide beneath leaves, therefore accurately estimating their population is extremely challenging. Most farmers rely on manual scouting, which is tedious, slow, and expensive.

To combat insects, chemical pesticides are employed, but several problems are observed as a result. For example, soil health is degraded and non-pest organisms eliminated when excess chemical pesticides are applied. Additionally, contamination of water sources is caused by pesticide runoff, posing risks to both human and animal health. Over time, resistance to pesticides is developed by many insect species as a result of excess pesticide application, rendering such treatments less effective.

While insect populations tend to congregate in select areas, farmers apply chemical pesticides to crops in their entirety. As a result, pesticides are often applied to significant portions of farmland for which there is no need. This is not only wasteful, but also exacerbates existing issues associated with chemical pesticides, such as those enumerated above.

Expeditious growth of human population has increased the consumption of food products significantly, in turn increasing demand for innovative farming practices. In recent years, Smart Connected Farms (SCFs) have become an increasingly relevant area for improving the quantity and quality of food produced through agricultural farming. Smart Connected Farms are characterized by the integration of advanced technologies such as sensors, IoT devices, and data analytics (e.g., via machine learning) to enhance agricultural productivity. Real-time information is gathered from various sources, including soil, weather, farming practices, and crop conditions, facilitating personalized data-driven decision-making. Farm operations are optimized with the help of automation and remote monitoring. Resources are applied more efficiently, and environmental impacts are minimized. By adopting SCF systems, improved yields and sustainability are achieved in modern agriculture.

### SUMMARY

In an embodiment, a field analysis system includes at least one sensor station, a field data processor, and two wireless transmission devices. The sensor station comprises an imaging device configured to capture image data of a field under analysis, at least one agricultural sensor configured to generate sensor data representative of a condition of the field under analysis, and a first wireless transmission device. A second wireless transmission device is coupled to the field data processor and, in conjunction with the first wireless transmission device, enables communication between the field data processor and the at least one sensor station. The first and second wireless transmission devices further enable communication between the field data processor and a remote access device. The field data processor is configured to receive and respond to the captured image data and the sensor data from the at least one sensor station.

In another embodiment, a method of generating a field action is disclosed. The method comprises training at least one sensor station processor to generate insect population data from image data associated with an insect population, receiving the insect population data from the at least one sensor station processor, and generating a prescribed field action based on at least the insect population data. Training the at least one sensor station is performed using a machine-learning based object detection module. The insect population data is received by a field data processor which also generates the prescribed field action.

### BRIEF DESCRIPTION OF THE DRAWINGS

FIG. 1 is a diagram of a field analysis system according to an embodiment.

FIG. 2 is a perspective view of a sensor station of the field analysis system.

FIG. 3A shows a sticky trap having insects categorized according to a binary object identification module.

FIG. 3A shows a sticky trap having insects categorized according to a multi-class object identification module.

FIG. 4 is a block diagram of a field action generation method according to an embodiment.

FIG. 5 shows image transfer time as a function of distance for an example of the field analysis system.

FIG. 6 is a model performance chart for binary and multi-class object identification modalities of the example field analysis system.

FIG. 7 shows confusion matrices for object identification modalities of the example field analysis system.

FIG. 8 is a precision-recall curve for the binary object identification modality of the example field analysis system.

Corresponding reference characters indicate corresponding parts throughout the drawings.

### DETAILED DESCRIPTION

Throughout the present disclosure, the term “insect” is used at length. Those skilled in the art will recognize that, in the field of the present disclosure, the term “insect” is used colloquially to refer to a large variety of animals which are not necessarily members of the class “insecta.” For example, spiders, scorpions, centipedes, millipedes, and mites (e.g., ticks) may all be referred to as insects. Thus, the term “insect” as used throughout the present disclosure should not be interpreted as limiting in its literal scientific sense, but as a flexible term of art which refers to a large swath of creatures (similar to “bugs”).

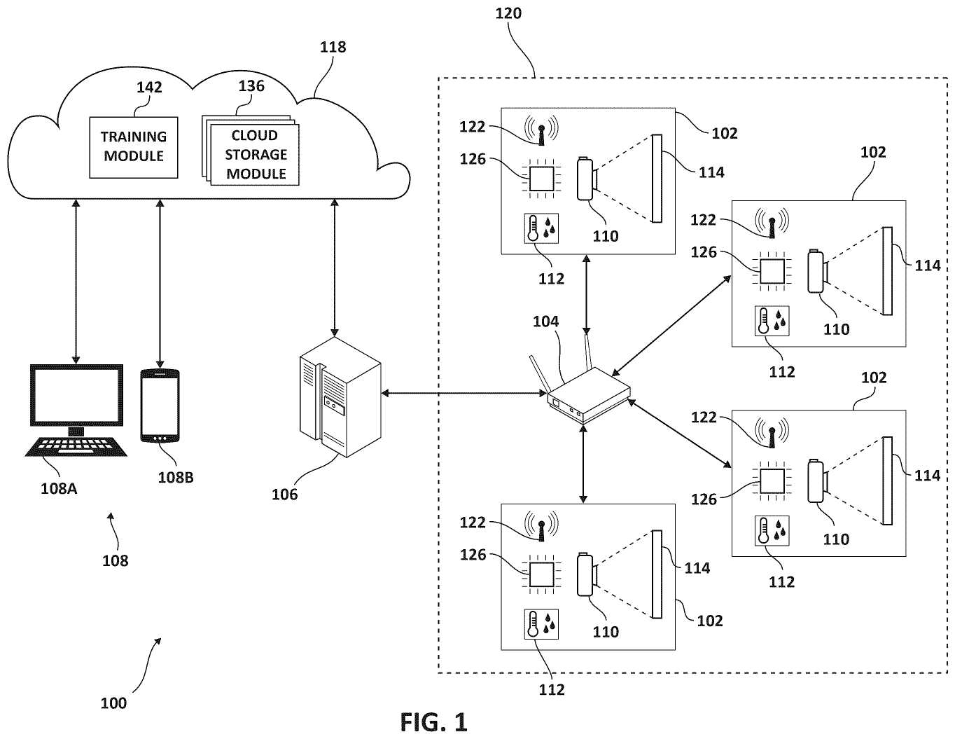

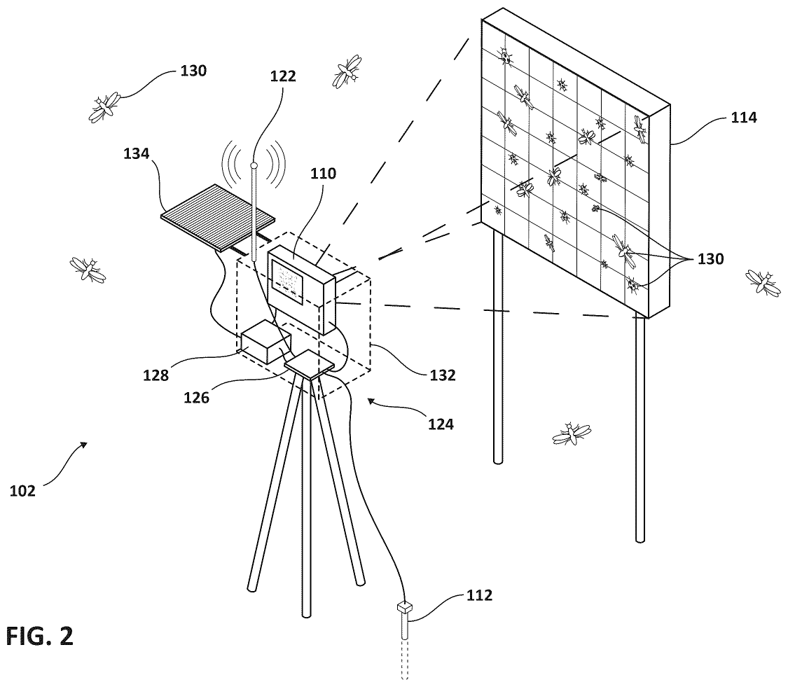

Referring to FIGS. 1 and 2, a field analysis system (broadly, the system) is shown schematically, and is generally indicated at reference number 100. The system 100 generally comprises a plurality of sensor stations 102, a field data processor 104, a gateway server 106, and at least one access computing device 108. Each of the sensor stations 102 includes an imaging device 110, at least one agricultural sensor 112, and a sticky trap 114. According to an embodiment, the field data processor 104 is configured to receive and analyze data collected from the plurality of sensor stations 102. Each of the sensor stations 102 intermittently collects data in the form of image data comprising images taken of the sticky trap 114 by the imaging device 110, and sensor data taken from the at least one agricultural sensor 112. Using an object-detection module, for example, a sensor station processor 126 extracts insect population data from the image data. These data (e.g., field data) are transmitted to the field data processor 104 where it is analyzed/processed. The field data processor 104, using these data, is configured to prescribe a field action and transmit it to the gateway server 106. The gateway server 106 is accessible by the access computing device(s) 108 via the internet/cloud 118. As will be explained in greater detail throughout the present disclosure, the field analysis system 100 provides real-time data regarding insect populations within a field 120 and generates a field action prescription tailored thereto. In an embodiment, a field data memory device (not shown) coupled to the field data processor 104 stores processor-executable instructions that, when executed, configure the field data processor 104 to generate the field action prescription.

Each sensor station 102 is positioned within the field 120 to collect field data therefrom. The sensor stations 102 are the foundation of the field analysis system 100, as they collect the field data (e.g., image data, sensor data) used to inform farmers of insect population distribution/trends at or near the field 120. The sensor stations 102 are spaced apart from one another within the field 120 such that a large area may be covered. The distance at which they are separated may be adjusted to account for such factors as wireless connectivity or insect concentration. In the illustrated embodiment, there are four sensor stations 120, however any number of sensor stations 102 may be employed to adequately survey the field 120. For example, two or three sensor stations 102 may be adequate for a small field (e.g., 1-10 acres), whereas dozens of sensor stations 102 may be required to adequately survey a large field (e.g., 100 acres). The sensor stations 102 are preferably placed in close enough proximity to the field data processor 104 that they may reliably communicate therewith. In an embodiment, each sensor station 102 includes a wireless transmission device 122 (e.g., an antenna) configured for this purpose. In certain embodiments, the wireless transmission 122 device is a long-range (e.g., LoRa) device configured to provide reliable communication at great distance (e.g., 5 mile, 10 miles, 10 miles, 20 miles, 30 miles, etc.).

Referring to FIG. 2, the sensor stations 102 will be described in greater detail. Each sensor station 102 includes an electronics module 124 and a sticky trap 114 spaced apart from one another. The electronics module 124 retains the electronic components of the sensor station 102: namely, the imaging device 110, the sensor station processor 126, the agricultural sensor 112, and a power source 128. The sticky trap 114 includes a substantially planar sticky paper configured to trap insects 130 on the surface thereof. The sticky trap 114 includes a plurality of sticky papers layered on top of one another. In this way, a new sticky paper may be exposed by simply peeling off the outermost layer. In certain embodiments, the sensor station 102 includes an automated peeler (not shown) for removing the outermost layer of the sticky trap 114 in order to clear it of insects. Both the electronics module 124 and the sticky trap 114 are at an elevated position with respect to the ground in order to protect the components thereof (e.g., from water damage, from sediment deposition, etc.). An elevated position provides the additional benefit of making the sensor station 102 easier to locate (e.g., for maintenance or repairs, or to avoid agricultural equipment such as combines or tractors). While not illustrated, identifying markers (e.g., a flag) may be included for improved visibility.

The electronics module 124 includes a housing 132 for holding the components thereof, and for protecting them from exposure to the elements. The housing 132 includes at least one opening for allowing the imaging device 110 to look therethrough. The opening is preferentially covered by a lens for maintaining the protective function of the housing 132.

The imaging device 110 is arranged such that its field of view is aligned with and perpendicular to the sticky trap 114. Thus, the imaging device has a clear view by which to image the sticky trap 114 for gathering image data (e.g., real time images). In the illustrated embodiment, imaging device 110 is communicatively coupled to the sensor station processor 126 via a wired connection and is controlled thereby. The imaging device 110 is electrically coupled to the power source 128 via a wired connection, and receives power therefrom. The electronics module 124 is configured to be compatible with a variety of imaging devices, including consumer-grade recreational cameras (e.g., handheld digital cameras).

The agricultural sensor 112 is located outside of the housing 132, but is electrically connected to the sensor station processor 126 via a wired connection. The agricultural sensor 112 provides sensor data to be used in conjunction with the image data acquired by the imaging device 110; as will be explained in greater detail later in the present disclosure, an abundance of data improves the ability of the field data processor to accurately assess insect distribution and prescribe a response (e.g., pesticide allocation). The agricultural sensor 112 may be any environmental sensor, including a temperature sensor, a humidity sensor, a UV sensor, a soil moisture sensor, a soil pH sensor, a generic weather sensor, a global positioning system (GPS), a rain gauge, an air quality sensor, a chemical sensor, etc. The illustrated agricultural sensor 112 is a soil moisture sensor.

The power source 128 is configured to provide electrical power to the components of the electronics module 124, including the imaging device 110, agricultural sensor 112, sensor station processor 126, and wireless transmission device 122. The power source 128 of the illustrated embodiment is a rechargeable battery, which is recharged by a solar panel 134.

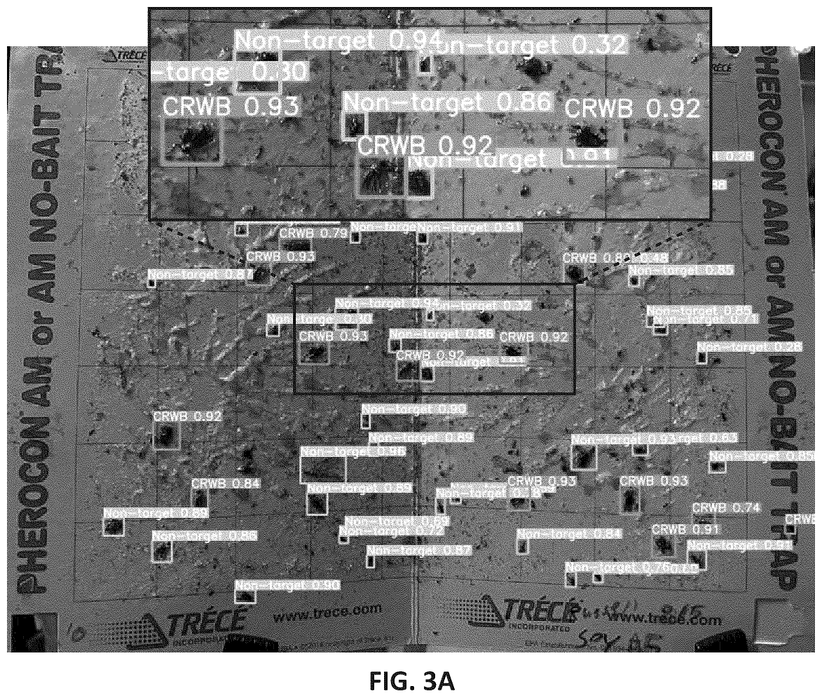

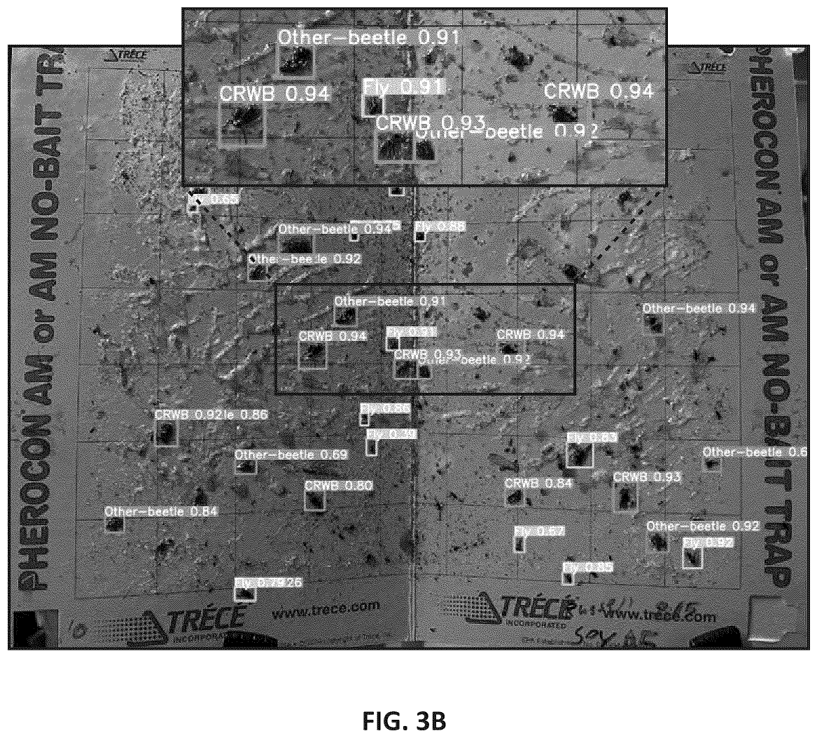

The sensor station processor 126 controls all the components of the electronics module 124. For example, according to software stored on a sensor station memory device (not shown), the sensor station processor 126 intermittently engages the imaging device 110 to collect or capture image data associated with the sticky trap 114 (e.g., to take a photograph thereof). The sensor station processor 126 may transmit this data (e.g., field data) to the field data processor 104 via the wireless transmission device 122. A similar process is performed with sensor data collected from the agricultural sensor 112. The sensor station processor 126 may be configured to transmit the data instantaneously (e.g., as it is received/collected), but may also be configured to transmit the data in batches (e.g., piecemeal, on a time-interval basis, etc.). As will be explained in greater detail below, the sensor station processor 126 is configured to execute an object-detection module for identifying and distinguishing insects in the images of the sticky trap 114 captured by the imaging device 110. The object-detection module includes machine-learning protocols acquired at a training module 142 (see FIG. 1) using data stored remotely in a cloud storage module 136 (see FIG. 1). The object-detection module is configured to perform both binary classification (e.g., insect X or not insect X) and multi-class classification (e.g., insect X, Y, Z, or UNKNOWN). See FIGS. 3A and 3B for examples of these, respectively.

In certain embodiments, the sensor station processor 126 and sensor station memory device are part of a consumer-grade single-board computer (e.g., a Raspberry Pi, an Arduino, etc.). By using such electronics, the sensor station processor 126 is easily programmable, cheap, and easy to replace. Additionally, since the sensor station memory device is incorporated into the single-board computer, there is no need to separately include a digital storage medium in connection with sensor station processor 126.

Referring again to FIG. 1, each sensor station 102 is in wireless communication with the field data processor 104. The field data processor 104 serves as a local base station for collecting data from the sensor stations 102. The sensor stations 102 are configured to transmit such data to the field data processor 104. The data may be raw, unprocessed data (e.g., images of sticky traps 114 or readings from an agricultural sensor 112) but may also be data processed according to the object-detection module (e.g., insect population data, predictive data). Both unprocessed and processed data may be transmitted together. The field data processor 104 is connected to the cloud 118 via the gateway server 106 configured to facilitate the exchange of data therebetween. The cloud storage module 136 and the training module 142 are stored remotely (e.g., in/via the internet 138), and are accessible to the field data processor 104.

The cloud storage module 136 is configured to store any and all forms of data collected and/or processed by the field data processor 104 or sensor station 102. This data is remotely accessible via any access computing device 108 having internet connectivity, e.g., via a computer 108A or a smartphone 108B. For example, a user (e.g., a farmer) may want to check the status of a particular sensor station 102 for ascertaining an estimate of a particular insect population thereat. To do so, the user accesses the cloud storage module 136 from a respective computing device 108 (e.g., their smartphone 108B). The cloud storage module preferentially includes a sorted file system for facilitating quick and easy access to field data. The user, having a particular sensor station 102 in mind, can navigate to that station's file and view its contents (e.g., the most recent raw images of the station's stick trap 114, or processed data relating to insect population such as an insect count).

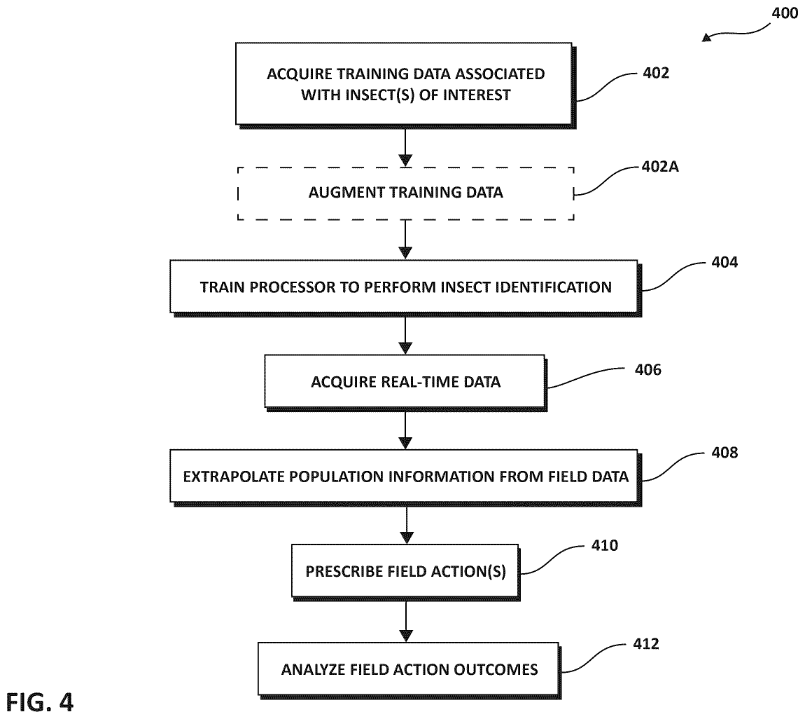

Referring to FIG. 4, a method for identifying and responding to changes in insect populations in a field is shown in the form of a flow chart and is generally indicated at reference number 400. The method 400 is configured to be implemented with the field analysis system 100 of FIGS. 1 and 2.

At operation 402, training data associated with one or more insects of interest are acquired. An insect of interest is simply an insect whose population levels are of interest to farmers. Most insects of interest are directly harmful to crop yields because they feed on, nest in, or otherwise deteriorate the structure of the plants themselves. Other insects (e.g., pollinators) of interest may be those which do not directly harm crop yields, but which encourage the development of insects that do (e.g., are a food source therefor). Some of the most common insects of interest to farmers are fall armyworms (Spodoptera frugiperda), corn earworms (Helicoverpa zea), western corn rootworms (Diabrotica virgifera virgifera), Colorado potato beetles (Leptinotarsa decemlineata), soybean aphids (Aphis glycines), green peach aphids (Myzus persicae), cabbage loopers (Trichoplusia ni), diamondback moths (Plutella xylostella), potato leafhoppers (Empoasca fabae), spotted wing drosophilas (Drosophila suzukii), codling moths (Cydia pomonella), oriental fruit moths (Grapholita molesta), stink bugs (e.g., Halyomorpha halys, Nezara viridula), two-spotted spider mites (Tetranychus urticae), corn leaf aphids (Rhopalosiphum maidis), tobacco budworms (Chloridea virescens), European corn borers (Ostrinia nubilalis), alfalfa weevils (Hypera postica), whiteflies (Bemisia tabaci), and pea aphids (Acyrthosiphon pisum). Insects of interest may include insects which positively affect crop yields, and whose populations farmers wish to maintain/increase (e.g., benign insects that prey on pest insects).

Training data associated with the one or more insects of interest comprises image data which includes the insect of interest (e.g., many photos of the insect). A large set of training data is required to adequately train an object-detection module to accurately identify (e.g., categorize) insects in images. For certain insects, databases of training data may already exist which may be utilized to help train the object-detection module. However, the context in which later photographic data associated with the insect will be acquired is relevant to the type of data used to train the object-detection module. For example, with respect to the sensor station 102 of FIG. 2, a sticky trap 114 having a generally planar surface and a plurality of grid lines is used to trap insects for imaging by the imaging device 110. In this context, training data should optimally be acquired through such imaging techniques. If photographic structures (e.g., the background, the image resolution, the exposure, other insects which are not of interest, etc.) vary significantly between the training data and the later acquired “real” data, the object-detection module will exhibit reduced performance (e.g., the object-detection module will be less accurate and less reliable). For example, acquiring photographic training data which includes only the insect of interest will not teach the object-identification module to distinguish between the insect of interest and other insects or objects which may be present in photographs acquired in the field.

The acquired training data includes—or is made to include—identification information by which to verify and improve the efficacy of the object-identification module. That is, each insect in the training data should be identified individually (e.g., by an agronomist, entomologist, or crop consultant). This may entail the laborious task of manually identifying thousands of insects in the training data; the performance of the object-detection module is a direct result of the accuracy with which this step is done.

At operation 402A, the training data is augmented. Operation 402A is optional and preferentially performed when the training data set is not sufficiently robust to adequately train an object-identification module. Image rotation may be applied to simulate various viewing angles, allowing the object-identification module to learn insect features irrespective of orientation. Scaling and zooming may be employed to vary the size of insects within images, assisting the module in becoming invariant to distance or object size variations. Horizontal and vertical flipping may be used to increase data. Color jittering (e.g., random adjustments to brightness, contrast, saturation, and hue) may be utilized to simulate a diverse set of lighting conditions (e.g., sunny conditions, overcast conditions) and camera differences (e.g., if varied imaging devices are used for real-time data acquisition). Additionally, cropping and padding may be applied to mimic partial views or different framing, thereby enabling the object-identification module to better handle occlusions and diverse object positions. Noise injection, such as Gaussian noise, may be introduced to make the module resilient to sensor noise and image artifacts. These may be employed to any degree and in any combination to prevent overfitting, increase the effective size of the training set, and ultimately improve the generalization performance of the object-identification module.

At operation 404, a processor is trained to perform object identification (e.g., insect detection. The processor being trained may be sensor station processor 126 or field data processor 104. In a preferred embodiment of the method 400, the sensor station processor 126 is trained via the field data processor 104, which itself is trained via a remote connection to the training module 142; specifically, a trained object-detection module is downloaded to the sensor station memory device (e.g., a hard-drive) in communication with the sensor station processor 126 after having been trained by/at the cloud-based training module 142. The training module 142 accesses training data stored in the cloud storage module 136 (e.g., training data acquired at operation 402 and optionally augmented at operation 402A). The field data processor 104 transmits the trained object-detection module to one or more sensor-stations 102 (e.g., to local memory thereof) such that the sensor-stations 102 are capable of performing real-time inference (e.g., extracting insect population data via insect detection) on images collected thereat. Training the processor(s) may be performed in any way which enables them to distinguish between insects of interest and other insects. Additionally, the processors' connection to the cloud 118 means that the object-detection module may be updated (e.g., improved) at any time. For example, as more image data is collected from the sensor stations 102, a more diverse training data set may be assembled which can then be used to improve the object-detection module's performance.

At operation 406, real-time data is acquired. In the illustrated embodiment of the field analysis system 100 of FIG. 1, for example, the means for acquiring real-time field data includes installing (e.g., positioning within a field) the imaging device 110 and the sticky trap 114. Together, the imaging device 110 and the sticky trap 114 are capable of repeatedly and autonomously collecting image data to be analyzed by the object-detection module established at operation 404. In certain embodiments, the automated peeler is included at the sensor stations 102 for repeatedly removing the outermost layer of the sticky-trap 114 (e.g., the exposed layer) such that a clear imaging canvas is provided on a time-interval basis (e.g., once a day). In this way, the imaging device 110 and the sticky-trap 114 can operate for extended periods of time without user attention. The real-time data acquired at operation 406 is then processed (e.g., analyzed) using the object-detection module (e.g., at one or more of the sensor station processors 126) to yield insect population data (e.g., an insect count for one or more insects of interest).

At operation 408, population levels are extrapolated from the data acquired and processed (e.g., analyzed, inferenced) by the sensor stations 104 at operation 406, such that a number of insects are counted at each sensor station, for each insect of interest, and for each period of time over which the sensor station 102 is configured to collect field data (e.g., once an hour for twenty-four collections per day, once every two hours for twelve collections per day, every twelve hours for two collections per day, etc.). For example, in various embodiments of the method 400, the field analysis system 100 may be configured to:
Estimate, using the insect population data, population levels for the area (e.g., field) in which the sensor stations are positioned for at least one insect of interest;
Estimate, using the insect population data, population distributions for at least two insect types (e.g., 20% of the insect population is type X, 30% of the insect population is type Y, 45% of the insect population is type Z, and 5% of the insect population is unknown/unrecognized) for the area (e.g., field) in which the sensor stations are positioned; or
Extrapolate (e.g., predict), using the insect population data, a change in insect population in the form of a raw number or a rate for at least one insect type (e.g., a 5% increase in the population of insect type X each day for the next month, a 10,000 insect-per-day decrease in the population of insect type Y for the coming week, etc.).

Operation 408 may include other forms of analysis not listed above, including archiving insect population data for long-term use. Additionally, operation 408 may utilize data beyond the data acquired at operation 406; for example, operation 408 may utilize data acquired at various field analysis systems 100 to help predict changes in insect populations in the area (e.g., field(s)) from which the data of operation 406 is acquired. Operation 408 is, in a preferred embodiment, performed by the field data processor 116 of a field data processor 104, however operation 40 may be performed elsewhere (e.g., remotely via the cloud 118, at an access computing device 108, etc.).

In a preferred embodiment, operation 408 is performed using a machine-learning model configured to estimate (e.g., predict) insect population changes; such algorithms include, but are not limited to, Convolutional Neural Networks (CNN), Gated Recurrent Units (GRU), AutoRegressive Integrated Moving Average algorithms (ARIMA), Seasonal AutoRegressive Integrated Moving Average algorithms (SARIMA), random forest algorithms, gradient-boosted decision trees (GBT), Vector AutoRegression algorithms (VAR), Mean Squared Error algorithms (MSE), Multimodal Spatio-Temporal Vision Transformers, etc.

At operation 410, a field action is prescribed for addressing the results of operation 408. In existing farming methodologies, field actions are typically performed independently from any data which may inform their implementation. For example, farmers will crop dust an entire field at regular (e.g., fixed) intervals, with uniform distribution (e.g., at a fixed volume per unit area of field), and with fixed pesticide combinations (e.g., a standardized pesticide cocktail), even if they have inadequate knowledge of the insect populations for which the pesticides are applied. In doing so, farmers must spend heavily on the application of pesticide(s) where they may not necessarily be needed, on fuel for operating a crop-dusting plane or other pesticide-delivery machinery, on labor for paying machine operators (e.g., pilots), and on many other materials/procedures. This harms the environment through runoff and compromises the quality of produce by saturating it with chemicals. Operation 410 mitigates these negative consequences by providing an informed field action which is proportional to the detected/predicted insect levels acquired at operation 408.

Operation 410 includes prescribing at least one of a quantity (e.g., a volume or volume-per-unit-area), quality (e.g., a specific type of pesticide/insecticide/herbicide and its concentration or blend), and location of solution to be applied to the field 120. In a preferred embodiment, the quantity, quality, and location of a solution (e.g., pesticide) to be applied to the field 120 are all included as part of the prescribed field action.

For example, consider a scenario wherein operation 408 predicts a 50% daily increase in the population of pest insect X; in response, operation 410 prescribes a specific dose of pesticide configured to optimally eliminate insect X. Operation 410 specifies that the pesticide is to be delivered to the area wherein the population of insect X is concentrated. This is known because the insect population data yielded from operation 408 (from which the field action is calculated) includes the specific sensor station(s) associated therewith. Thus, the outbreak of insect X is addressed swiftly, (e.g., preemptively) with reduced expenditure of resources (e.g., reduced airtime for a crop-duster, reduced cost for labor and materials), and with minimal environmental impact. Under traditional farming practices, the outbreak of insect X would either be identified and addressed excessively (because the farmers have no knowledge of where the outbreak is concentrated), or not identified at all and left to fester until such a response is no longer excessive (e.g., wherein whole-field crop-dusting is in fact necessary).

In a preferred embodiment, operation 410 is performed using a machine-learning model. The model may be trained on a plurality of data, including well known data associated with the efficacy of certain insecticides/pesticides on given insect populations, and their interactions with certain crops.

At operation 412, following the implementation of the prescribed field action, field action outcomes are analyzed. Typically, the most important field action outcome is a reduction in the population of insects for which the field action was prescribed at operation 410. For example, if pesticide X was prescribed for insect X at operation 410, operation 412 would consist of examining the population of at least insect X following implementation of the field action. In practice, this is functionally indistinguishable from operation 406, wherein data (e.g., population data) is acquired; however, following a field action, newly acquired field data is analyzed within the context of the previously applied field action, and future field actions are therefore prescribed in light detected changes. With respect to the previous example, if operation 412 finds that insect X was significantly reduced through selective application of pesticide X, pesticide X may be favored (e.g., preferentially selected) for use against insect X in future field action prescriptions. If, however, operation 412 finds that the application of pesticide X also reduced populations of insects which prey on pest insects (e.g., spiders, ladybugs, etc.), pesticide X may be preferentially avoided in future field action prescriptions.

A purpose of the method 400 is to improve the speed and quality of field actions (e.g., application of pesticides/insecticides) by prescribing them on the basis of empirical data (e.g., an insect population count derived from field samples) as opposed to anecdotal data (e.g., a general observation of crop decline as a result of some insect population) or standardized procedure (e.g., rote application of pesticides).

### EXAMPLES

The field analysis system 100 was used to capture real-time images of yellow sticky-traps 114 using a camera (imaging device 110), and to accurately distinguish a target insect (i.e., corn rootworm beetles, abbreviated CRWB) from other structurally and visually similar flies and beetles. This was performed with eight low-cost sensor stations 102. The sensor station processors 126 were Raspberry Pis. The captured images were transferred to an in-field data processor 104 with the help of Long Range (LoRa) technology. A highly versatile, reliable machine-learning object detection framework—“You Only Look Once” (YOLOv8)—was trained in the cloud-based training module 142 and was deployed to the sensor stations 102 via the field data processor 104. Novel datasets were collected by deploying yellow sticky-traps in twenty farm fields in the state of Iowa in the United States. The range of the sensor stations 102 was approximately one mile.

The system 100 was created in four primary steps: data acquisition, dataset preparation, insect detection modeling, and real-time inference.

In the data acquisition step, focus was directed toward insects that negatively impact corn crops. For the growing seasons of 2021 and 2022, training images were gathered of corn rootworm beetles (CRWB) at the winged stage of their life cycle. This was accomplished by placing multiple sticky traps 114 in the farm fields between ten and twelve days prior to the emergence of the insects. For each field, the sticky traps 114 were situated approximately fifty feet apart from an edge of the field to the center of the field. The sticky-traps 114 placed in the middle were well-marked to avoid damage during cultivation, spraying, or other activities. Each sticky-trap 114 was monitored and inspected regularly. After having been saturated with insects, each sticky-trap was imaged by an 8-megapixel camera and subsequently uploaded to the cloud storage module 136.

For each of the eight sensor stations 102 in this example, the sensor station processor 126 was a “Raspberry Pi 4B” with 8 GB RAM, the imaging device 110 was an 8-megapixel camera having 64 GB of storage (i.e., via an SD card), and the wireless transmission device 122 was a LoRa communication module. A GPS was also included. For proof-of-concept, each sensor station 102 was connected to a personal computer which, in this example, may be considered the field data processor 104. A trained YOLOv8 model was downloaded as the object-detection module to validate real-time inference. Additionally, a designated web portal was hosted for remote access (e.g., via remote access computing devices 108) to the sensor stations 102 and on-demand capture of images.

In the dataset preparation step, the sticky-trap images were assembled and labeled to create a functional dataset configured for training the object-detection module. A “Labelbox” tool was used for collaborative labeling, during which tight bounding boxes (of varying sizes) were drawn around each insect of each image (including CRWBs, flies, and other beetles), and manually categorized. Each label was assigned for review by others. Categorization was later validated by an agronomist to ensure veracity, and all data was subsequently stored in a JSON file containing image information along with bounding box coordinates. FIGS. 3A and 3B show two sample images. Images which could not be confidently verified by the agronomist were rejected to maintain dataset integrity.

As the data collected in the seasons of 2021 and 2022 from corn fields were not sufficient for training (i.e., there were not enough images to accurately train the object-detection module), data augmentation techniques were leveraged to create more samples (i.e., to increase the volume of training data). Data augmentation was applied through tiling (dividing an image), mosaic, bounding box flip, and noise addition up to 5% of pixels. This was performed using the “Roboflow tool”. In mosaic, each image is partitioned into four parts. Each part is combined with parts of other images such that the existing dataset is expanded without compromising dataset uniformity and integrity. Following data augmentation, more than 1,000 images-having more than 6,000 target and 9,000 non-target insects of interest-were exported to YOLOv8 in a compatible format.

In the insect detection modeling step, the YOLOv8 object-detection module was trained to perform insect classification. The YOLOv8 model architecture has three main components: (i) Backbone—a pre-trained network to extract a set of informative features from the input image; (ii) Neck—a feature-pyramid generator to identify objects with varying scales and to generalize for test data; and (iii) Head—an anchor box generator for applying anchor boxes on the features to determine final bounding boxes along with objectness scores and class probabilities.

The detection of insects (objects) in the YOLOv8 model is a classification task. Initially, the model divides the input image into m×m segments (sub-images), each of which draws “b” bounding boxes around an insect if its center falls within the box. Each box is represented as a tuple of five parameters, including the height and width of the box (h, w) relative to the input image, the center coordinates (x, y) of the box, and a confidence value quantifying how close the predicted box is to the ground truth. For any i^{th} predicted box b; and an insect type (e.g., CRWB), the confidence is computed as:

$$Conf ( {b}_{i} ) = Pr ( CRWB ) \times IoU , \qquad ( 1 )$$

where Pr(CRWB)∈[0, 1] and IoU refers to the intersection of box b; with the rest of b−1 boxes over the union of all the “b” boxes. In the case where a bounding box does not have any insects in it, the confidence is 0. Lastly, the boxes with class-specific confidence scores lower than a set threshold are suppressed, and the rest are fine-tuned further.

With respect to the real-time inference step, upon successful training at the cloud-based training module 142, the model was transferred to the field data processors 104 (located in the farm fields) for real-time inference.

The inventors contemplate that the field analysis system 100 will be highly effective as a single node in a smart connected farm network. In such a network, the field analysis system 100 will be one of many distributed across a large area of farmland, and the insect population data may be shared amongst other systems or networks for improved response to infestation; long-range communication is highly desirable for achieving this goal. Thus, as proof-of-concept for data transfer in an SCF, the example field analysis system 100 was tested with images transferred over long distances wherein each image was sliced into smaller chunks of size 1 kb.

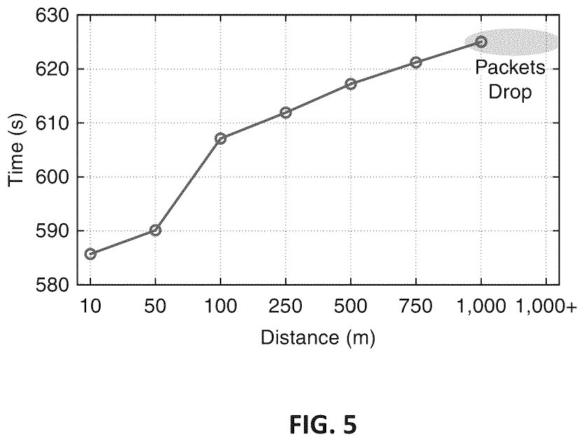

Referring to FIG. 5, the time taken for transferring an image of 100 kb from sensor station 102 to another sensor station is shown. FIG. 5 clearly indicates successful transmission up to 1000 meters in 622.5 seconds (approximately 10 minutes). Because the field analysis system 100 of the present disclosure requires that only a single image be recorded and uploaded (e.g., transferred) over a period of a few hours (e.g., thrice a day), the long-range communication test results of FIG. 5 indicate that it is suitable for use with an SCF. Moreover, for numerical values collected via one or more of the agricultural sensors 112 (e.g., temperature, soil moisture, etc.), only a few seconds are required.

### EXPERIMENTAL EVALUATION

To evaluate the system 100, the collected dataset was split into a training set (80%), a validation set (10%), and a test (10%) set. The object-detection module was trained and tested on a Dell Precision 7920 Tower with Intel Xeon Gold 6258R processor at 2.7 GHZ, 128 GB RAM, Dual 24 GB NVLink Nvidia RTX A5000, and 1 TB SSD. Note that the inference is carried out on this prototype.

### Hyperparameters and Evaluation Metrics

Four variations of the YOLOv8 object-detection module were employed: YOLOv8n (nano), YOLOv8s (small), YOLOv8m (medium), and YOLOv8l (large). The common hyperparameters were as follows: learning rate=0.01, input image size=640 px×640 px, momentum=0.9, IoU threshold=0.2, weight decay=0.0005, and epochs=200. Results were reported using standard object detection metrics-mean average precision (mAP) and classification scores-using a confusion matrix. The mAP is given as:

$$mAP = \frac{1}{N} {\sum }_{i = 1}^{N} {AP}_{i}$$

where “N” is the total number of classes, and “AP” is the average precision computed using a precision-recall curve; the higher the mAP, the better the detection capability of the model.

### Model Performance

Performance was evaluated for both binary and multi-class settings. For binary settings, images labeled “Fly” and/or “Other-beetle” were relabeled as “non-target.” This distinction is shown in FIGS. 3A and 3B.

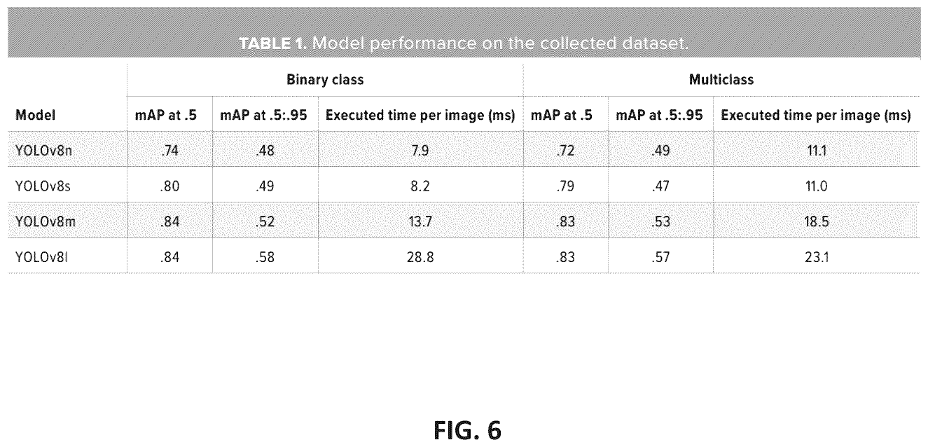

First, with respect to binary settings, experiments were conducted to detect and distinguish the target insect CRWB from non-target insects: results are shown in Table 1 of FIG. 6. Table 1 demonstrates the quality of information present in the collected images, thereby verifying the veracity of the data collection process. With the large model (i.e., YOLOv8l), the field analysis system 100 achieved higher detection accuracy compared to lower-size models (e.g., YOLOv8s). However, training was more time intensive and therefore may not be suitable for resource-constrained devices (e.g., sensor stations 102). Interestingly, YOLOv8m achieved almost the same mAP as YOLOv8l, suggesting that it may be chosen over the large model without meaningfully sacrificing performance.

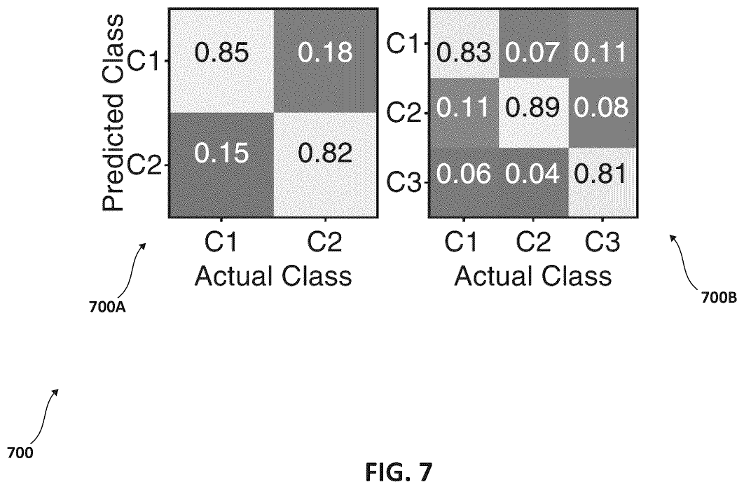

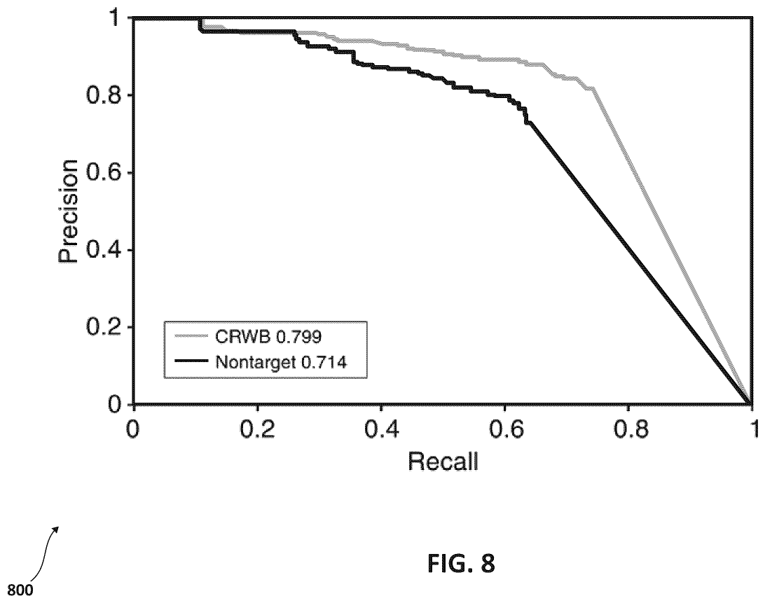

Evaluation metrics for classification accuracy are shown in the confusion matrices 700 of FIG. 7. A binary confusion matrix 700A shows that while the model can reliably distinguish CRWB from non-target insects (i.e., with 85% accuracy), it cannot reliably remove false positives. The inventors contemplate that this is the result merely of insufficient training data and an imbalance of samples across classes (e.g., an overrepresentation of non-target insects and an underrepresentation of target insects). As a result, the precision and recall tradeoff were also evaluated; the Precision-Recall curve is shown at reference number 800 of FIG. 8, and indicates a threshold point at which both precision and recall are maximized. The Precision-Recall curve was generated by adopting a standard 101 equally spaced points between 0 and 1, as mentioned in YOLOv8 metrics. Performance quality is proportional to the area under the Precision-Recall curve. The best thresholds for CRWB and Non-target insects were 0.799 and 0.714, respectively.

Second, to analyze performance with respect to multi-class settings, non-target insects were split into two classes: other-beetles and Fly. The model was trained again to account for this change. Except for the nano-size model (i.e., YOLOv8n), all models demonstrated reliable detection abilities at greater than 0.79 mAP at 0.5 on the testing data. Similar to the binary confusion matrix 700A, a multi-class confusion matrix 700B indicates that the multi-class model effectively identified the CRWB class with greater accuracy (e.g., above 80%) compared to other insect classes—even in the absence of sufficiently diverse training data.

As a result of increased recognition of the benefits of precision agriculture, significant efforts have been allocated to the development of machine-learning and IoT-based smart farming solutions, particularly in academia. However, farms have been primarily studied individually rather than collectively (e.g., according to an SCF concept); thus, several challenges still exist in achieving reliable SCF technology:
Deployment and communication: Most farms are located far from urban areas, and thus often lack reliable network connectivity (e.g., cellular reception). Because sensor stations 102 are configured to be spaced apart at considerable distances, data transfer cannot be accomplished via short-range communication methods (e.g., Bluetooth, Wi-Fi, etc.). While LoRa communication technology is a superior alternative to these methods, data transfer is slow. The inventors contemplate that LoRa presents a fertile area for research within the SCF framework.
Cost-benefit tradeoff: Farmer participation in SCF systems is largely determined by the extent to which better systems offer improved agricultural outcomes (e.g., greater crop yields, reduced costs for pesticides, improved environmental conditions, etc.). Likewise, industry-investment is unlikely if investment costs do not yield adequate returns. Thus, cost-benefit analyses are another important research area.
Data privacy: Significant losses may be incurred by farmers if information about crop quality is disclosed in combination with geographic data. For example, if an SFC system detects a population change in harmful insects (whether the population increases or decreases), a bad actor may seek to acquire such knowledge for malicious reasons (e.g., threatening the release of such information in exchange for a payment in the event of a pest population spike, selling the information to a competitor in the event of a pest population decline, etc.). On the other hand, interest in such information would be shown by farmers and crop insurance companies, thereby raising issues related to data privacy. Although Federated Learning is suggested as a means to train machine-learning models without data exposure, its implementation is hindered on sensor stations due to limited computational resources. As a result, an opportunity for research is presented in exploring Federated Learning on resource-constrained devices.

The present disclosure introduces a real-time field analysis system 100 as a first step toward realizing smart connected farms (SCF) in agriculture. By collecting real-world data from twenty farm fields belonging to eight farmers, the inventors have generated an insect dataset by which machine-learning models were trained for insect detection (e.g., identification).

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided, and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A field analysis system for surveying a field, comprising:
at least one sensor station, wherein the at least one sensor station comprises:
an imaging device configured to capture image data of a field under analysis;
at least one agricultural sensor configured to generate sensor data representative of a condition of the field under analysis; and
a first wireless transmission device;
a field data processor receiving and responsive to the captured image data and the sensor data from the at least one sensor station; and
a second wireless transmission device coupled to the field data processor;
wherein the first and second wireless transmission devices are configured to:
enable communication between the field data processor and the at least one sensor station; and
enable communication between the field data processor and a remote access device.

2. The field analysis system of claim 1, wherein the image data comprises images of insects within the field, wherein the at least one sensor station comprises a sensor station processor and a sensor station memory device communicatively coupled thereto.

3. The field analysis system of claim 2, wherein the sensor station memory device stores processor executable instructions that, when executed, configure the sensor station processor to:
execute an object detection module for detecting the insects in the captured images; and
generate insect population data therefrom.

4. The field analysis system of claim 3, further comprising a field data memory device coupled to the field data processor, wherein the field data memory device stores a prescription module that, when executed, configures the field data processor for prescribing a field action which is a function of at least the insect population data.

5. The field analysis system of claim 4, wherein the field data processor is configured to access a cloud server, the cloud server comprising a training module and a cloud storage module, wherein the object detection module and the prescription module are trained at the training module, wherein the object detection module is downloaded to the sensor station memory device via the field data processor, and wherein the prescription module is downloaded to the field data memory device.

6. The field analysis system of claim 4, wherein the remote access device is a computer or smartphone, and wherein the remote access device is configured to communicate with the field data processor through the cloud server.

7. The field analysis stem of claim 4, wherein the prescription module includes a machine-learning algorithm configured to optimize the field action.

8. The field analysis system of claim 4, wherein the field action includes a chemical type, a chemical quantity, and an application location.

9. The field analysis system of claim 3, wherein the object detection module comprises a You Only Look Once (YOLO) algorithm.

10. The field analysis system of claim 3, wherein the insect population data includes an insect count for at least two species of insect.

11. The field analysis system of claim 2, wherein the sensor station processor and sensor station memory device are part of a single-board computer.

12. The field analysis system of claim 1, wherein the at least one agricultural sensor includes a global positioning system (GPS), a soil pH sensor, a soil moisture sensor, a crop moisture sensor, a humidity sensor, or a temperature sensor.

13. The field analysis system of claim 1, further comprising a sticky trap in proximity to and in view of the imaging device, the sticky trap being configured to trap insects thereon.

14. The field analysis system of claim 1, wherein the at least one sensor station comprises a plurality of sensor stations spaced apart within the field.

15. A method of generating a field action, comprising:
training, using a machine-learning based object detection module, at least one sensor station processor to generate insect population data from image data associated with an insect population;
receiving, by a field data processor, the insect population data from the at least one sensor station processor;
generating, by the field data processor, a prescribed field action based on at least the insect population data.

16. The method of 15, further comprising collecting the image data using an imaging device communicatively coupled to the at least one sensor station processor.

17. The method of claim 16, wherein the image data comprises images of insects trapped on a sticky trap in proximity to the imaging device.

18. The method of claim 15, wherein the insect population data includes an insect count for at least two species of insect.

19. The method of claim 15, further comprising sending the prescribed field action to a remote access device.

20. The method of claim 15, wherein the prescribed field action includes a chemical type, a chemical quantity, and an application location.
